(19) United States
(12) Patent Application Publication
(10) Pub. No.: US 2011/0213634 A1
(43) Pub. Date: Sep. 1, 2011

(54) SYSTEM AND METHOD FOR EFFECTIVE WORKLOAD DISTRIBUTION FOR SERVICE TECHNICIANS

(75) Inventors: Buddy George Karakey, Scottsdale, AZ (US); Weston McArtor, Cody, WY (US); Gregory Scott Moseley, Milford, PA (US); Matthew John Peters, Eden Prairie, MN (US); Guy V. Worzel, SR., Ocala, FL (US); Steven R. Sharkey, Overland Park, KS (US)

(73) Assignee: Business Equipment Information Services, Inc., Cody, WY (US)

(21) Appl. No.: 13/038,306

(22) Filed: Mar. 1, 2011

Related U.S. Application Data
(60) Provisional application No. 61/309,392, filed on Mar. 1, 2010.

(51) Int. Cl. G06Q 10/00

(52) U.S. Cl. 705/7.14

(57) ABSTRACT

Disclosed is a software/computer based system/method that optimizes assignment of a service technician's territory (i.e., geographic area assigned to a service technician to support) based on a number of factors, particularly, the number and type of serviceable units in a territory, the usage history of the serviceable units (i.e., how often units may malfunction based on volume of use), and the historical expertise and efficiency of the technician in performing various types of expected repairs. Optimization goals include assigning service territories to service technicians such that each service technician is working 40 hours (or some other hourly goal) per week with few overtime hours (i.e., upset customers waiting for service) or under time (i.e., paying for time the service technician is not working for a customer). For example, copier repair technicians may be assigned to territories depending on how well the technicians have historically performed repairs on particular copier models. If a first technician is exceptionally fast and efficient, the first technician may be assigned an effectively larger workload area (i.e., more serviceable units) than a second technician that has a more average performance record.

### CROSS REFERENCE TO RELATED APPLICATIONS

This application is based upon and claims priority to U.S. provisional application Ser. No. 61/309,392, filed Mar. 1, 2010, entitled “A System and Method for Effective Workload Distribution for Service Technicians,” all of which is specifically incorporated herein by reference for all that it discloses and teaches.

### BACKGROUND OF THE INVENTION

Traditionally, service technicians are assigned to work areas using a manual process. In many cases, the assignment is a basic seat-of-the-pants method of assigning more units to technicians a supervisor intuitively believes are more effective and less to technicians the supervisor believes are less effective (such as new employees). In more sophisticated systems some type of historical evaluations may be kept on technician performance, but it is still up to the supervisor to look at the general performance evaluation of the technicians and assign territories/equipment units to each technician.

### SUMMARY OF THE INVENTION

An embodiment of the present invention may comprise a computerized method for optimally assigning service territories to a service technician comprising: providing access to a database stored on computer readable media by a computer system, the database containing geographic location data, unit type data, historical usage data, and historical repair data for each serviceable unit of a plurality of serviceable units, the database further containing historical repair success data and historical repair time data for each service technician of a plurality of service technicians; selecting by the computer system a territory geographic area of interest; selecting by the computer system a subset of serviceable units from the plurality of serviceable units stored in the database such that the subset of serviceable units contains serviceable units of the plurality of serviceable units that have the geographic location data located within the territory geographic area of interest; selecting by the computer system a service technician from the plurality of service technicians stored in the database; calculating by the computer system an aggregated technician demand time as a function of the unit type data of the selected subset of serviceable units, the historical usage data for each serviceable unit of the selected subset of serviceable units, the historical repair data for each serviceable unit of the selected subset of serviceable units, the historical repair success data for the selected service technician, and the historical repair time data for the service technician stored in the database; recalculating the aggregated technician demand time by the computer system dynamically if characteristics of the territory geographic area of interest change; and displaying results of the calculations and the recalculations dynamically as the calculations and the recalculations are performed to a user.

An embodiment of the present invention may further comprise a system for optimally assigning service territories to a service technician comprising: a computer system that performs functions of the system for optimally assigning service territories; computer readable media accessible by the computer system; a database stored on the computer readable media and accessible to the computer system, the database containing geographic location data, unit type data, historical usage data, and historical repair data for each serviceable unit of a plurality of serviceable units, the database further containing historical repair success data and historical repair time data for each service technician of a plurality of service technicians; a territory geographic area selection engine running on the computer system that selects a territory geographic area of interest and selects a subset of serviceable units from the plurality of serviceable units stored in the database such that the subset of serviceable units contains serviceable units of the plurality of serviceable units that have the geographic location data located within the territory geographic area of interest; a service technician selection engine that selects a service technician from the plurality of service technicians stored in the database; an aggregated technician demand timer calculation engine that calculates an aggregated technician demand time as a function of the unit type data of the selected subset of serviceable units, the historical usage data for each serviceable unit of the selected subset of serviceable units, the historical repair data for each serviceable unit of the selected subset of serviceable units, the historical repair success data for the selected service technician, and the historical repair time data for the service technician stored in the database and that recalculates the aggregated technician demand time dynamically if characteristics of the territory geographic area of interest change; and a display results engine that displays results of the calculations and the recalculations dynamically as the calculations and the recalculations are performed to the user.

### BRIEF DESCRIPTION OF THE DRAWINGS

In the drawings,

FIG. 1 is a general flowchart of the operation of an embodiment that assigns a service territory to a service technician.

FIG. 2 is a schematic illustration of the “Work Area” page of a user interface of an embodiment that may be used as a “start” (i.e., initial/opening) page for an embodiment, that permits a user to select the initial geographic area (i.e., “work area”) in which serviceable units are to be included, and that may also allow a user access to other areas via control dropdown menus

FIG. 3A is a schematic illustration of the Work Area page user control menu for the “Go” control/button on the Work Area page that permits a user to navigate to other pages/areas for an embodiment.

FIG. 3B is a schematic illustration of the Work Area page user control menu for the “Unmapped” control/button on the Work Area page that permits a user to navigate to other pages/areas for an embodiment.

FIG. 3C is a schematic illustration of the Work Area page user control menu for the “Workareas” control/button on the Work Area page that permits a user to navigate to other pages/areas and/or listings of work areas created for an embodiment.

FIG. 4 is a schematic illustration of an “inclusion” page for selecting which serviceable types of units, customers and technicians to include and/or exclude from a service territory for an embodiment.

FIG. 5 is a schematic illustration of territory page/feature that provides an interface for creating, viewing and editing technician territories within a work area for an embodiment.

FIG. 6A is a schematic illustration of the Manufacturers accordion dropdown selector list showing a list of potential manufacturers for an embodiment.

FIG. 6B is a schematic illustration of the Segments accordion dropdown selector list showing a list of potential segments for an embodiment.

FIG. 6C is a schematic illustration of the Models accordion dropdown selector list showing a list of potential models for an embodiment.

FIG. 6D is a schematic illustration of the Customers accordion dropdown selector list showing a list of customers with equipment in a work area/territory.

FIG. 6E is a schematic illustration of the Technicians accordion dropdown selector list showing a list of available technicians that may be assigned to a territory.

FIG. 6F is a schematic illustration of the Territory page user control menu for the “Go” control/button on the Territory page that permits a user to navigate to other pages/areas for an embodiment.

FIG. 6G is a schematic illustration of the Territory page user control menu for the “Reports” control/button on the Territory page that permits a user to create and view the report associated with a selected menu item for an embodiment.

FIG. 6H is a schematic illustration of the Territory page user control menu for the “Territories” button/control on the Territory page that permits a user to create a new territory or select an already created territory in a work area for an embodiment.

FIG. 6I is a schematic illustration of the Territory page user control menu for the “Display” button/control on the Territory page that permits a user to manage whether or not various items are displayed on the Territory page for an embodiment.

FIG. 7 is a detailed flowchart of an embodiment using a map based interface to set sample territories (i.e., geographic area of interest) for an embodiment.

FIGS. 8A-G are detailed flowcharts describing operations for various buttons of a map based user interface of the Work Area and Territory pages for an embodiment.

FIG. 8A is a flow chart describing a process for generating a territory based assignments.

FIG. 8B is a flow chart describing a process for generating car stock.

FIG. 8C is a flow chart describing the process for saving a work area.

FIG. 8D is a flow chart describing the process for loading a work area.

FIG. 8E is a flow chart describing the process for loading a territory.

FIG. 8F is a flow chart describing the process for territory integrity checks.

FIG. 8G is a flow chart describing the process for reports. ???2

FIG. 9 is a schematic illustration of a technician performance report for an embodiment.

### DETAILED DESCRIPTION OF THE EMBODIMENTS

An embodiment may provide an automated system of evaluating technician performance and dynamic updates for assigning territories/equipment units to each technician. An embodiment may further provide calculations on a model/unit-by-model/unit basis so that technicians that work well with particular models/units may be assigned those models/units and technicians that have trouble with particular models/units may not be assigned those models/units.

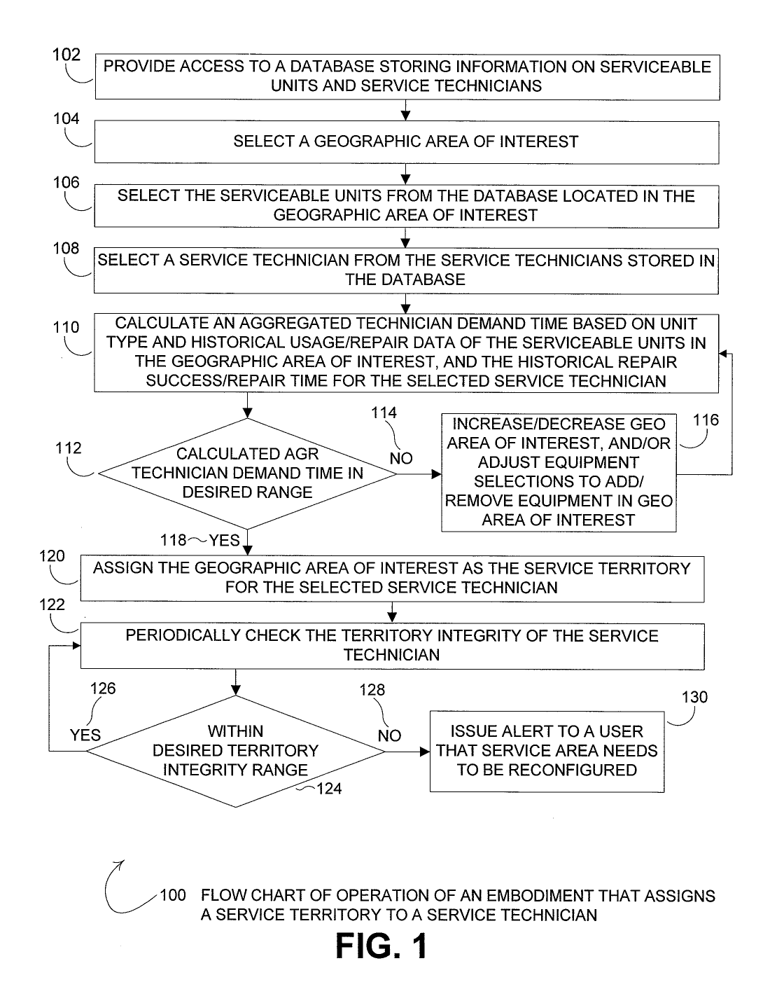

FIG. 1 is a general flowchart 100 of the operation of an embodiment that assigns a service territory to a service technician. At step 102, a database storing information regarding serviceable units is made accessible to a computer system that performs the operations to optimally assign a service territory to a service technician. The database may contain a wide variety of data, including, but not limited to: geographic location data of serviceable units, unit type/model of serviceable units, owner/customer data for serviceable units, historical usage data for serviceable units, historical repair data for serviceable units, home geographic location data for service technicians, repair certification data for service technicians, historical repair success data for service technicians (including on a per model type basis), and historical repair time data for service technicians (including on a per model type basis). The database may be a single large instantiation of a database, or a combination of smaller databases accessed such that the data is available to the computer system for use in performing the operations of an embodiment. Serviceable units may be any device, system, apparatus, etc. that is worked on by service technicians. Good examples of serviceable units are imaging devices such as copiers, printers, scanners, etc. Accordingly, the service technician in the imaging devices example would be the classic copier repair man.

At step 104, a geographic area of interest is selected. Some embodiments may provide mapping and boundary utilities to present a user friendly interface to the geographic area selection. Some mapping functionality permits live, dynamic updates of the borders and content of geographic areas as a user changes the selected borders for a geographic area of interest. However, lists of points and other commonly available methods for defining a geographic area may also be used as long as a geographic area of interest may be accurately depicted. At step 106, the serviceable units located within the geographic area of interest are located and grouped together. More sophisticated options for an embodiment may filter which serviceable units are made available based on additional criteria beyond location within the geographic area of interest. For example, some embodiments may filter out units which a service technician is not qualified to work on, some embodiments may filter units based on owners/customers, and/or some embodiments may filter out units located too far away from the home location of the service technician. At step 108, a service technician is selected from the available service technicians found in the database. Some embodiments may not permit service technicians to be selected for a geographic area of interest if some point/unit within the service area is located too far away from the home location of the service technician. The distance from the service technician's home is a predetermined, configurable value such that a user may change the distance value, but the distance value is set prior to evaluating whether the service technician lives too far away from some or all of the selected serviceable units.

At step 110, an aggregated technician demand time (FIG. 10) is calculated that determines the monthly anticipated time demand on the service technician to service the aggregated serviceable units located in the geographic area of interest. The aggregated technician demand time calculation is a function of the unit type data of the selected subset of serviceable units, the historical usage data for each serviceable unit of the aggregated set of serviceable units, the historical repair data for each serviceable unit of the aggregated set of serviceable units, the historical repair success data for the selected service technician, and the historical repair time data for the service technician stored in the database. At step 112, the aggregated technician demand time is compared to a range of desired technician demand time values. If the calculated technician demand time value does not fall within the desired range 114, then at step 116, the geographic area of interest may be increased if the aggregated technician demand time is too small or the geographic area of interest may be decreased if the aggregated technician demand time is too big. Adjusting the geographic area of interest to be bigger are smaller may be performed to adjust the equipment selections to add (i.e., increase) or remove (i.e., decrease) the equipment assigned to a geographic area of interest. Accordingly, an embodiment if an embodiment adds/removes equipment to/from a geographic area of interest is may be considered to be increasing/decreasing the size of the geographic area of interest for an embodiment even if the actual geographic location size is not changed as the amount of equipment assigned is the parameter that affects the aggregated technician demand time. From step 116, an embodiment returns to step 110 and recalculates the aggregated technician demand time for the adjusted geographic area of interest. This evaluation may be performed automatically on the computer system by uniformly increasing or decreasing the size of the geographic area of interest until an area results in an acceptable aggregated technician demand time value. In a system providing mapping functionality, a user may prefer to use the computer system to manually adjust the border sizes to desired dimensions and then recalculate the aggregated technician demand time. In some embodiments, either manually through the user interface or automatically without user intervention, it may also be desirable to switch the selected service representative to evaluate the effect on the time due to the historical efficiency and effectiveness of different service technicians. The desired aggregated technician demand time may also be configured to match a range of values desired by a system user.

At step 112, if the aggregated technician demand time falls within the desired range 118, the system moves to step 120. At step 120, the geographic area of interest is assigned as the service territory for the selected service technician. This assignment may be recorded in the database by associating the selected service technician with each of the serviceable units in the service territory. A list, such as a CSV (comma separated variable), XML, or other data file types known in the art may be sent to an Enterprise Resource Planning (ERP) system that records the assignment of the service technician to each of the serviceable units located within the service territory. At step 122 (optional), the system may periodically check the territory integrity (see description below) of the service technician. At step 124, the territory integrity of the service technician is evaluated to see if the territory integrity is within a desired (configurable) range. If the territory integrity is within the desired range 126, the system returns to step 122 and waits for the completion of another time period to re-evaluate the service technician's territory integrity. A common period is a month, but any desired period may be used at the discretion of the system developer. If the service technician's territory integrity is not within the desired range 128, the system moves to step 130 and issues an alert/notice that a service area may need to be reconfigured.

The remaining disclosure is predicated on a system where the serviceable unit is an imaging device such as a copier, printer, scanner, etc. As noted above, for various embodiments, serviceable units do not have to be imaging units and service technicians do not have to be copier repair technicians. The use of the imaging device/copier repair technician is a concrete example of a real world embodiment.

Effective Workload Distribution (EWD) Integrated with Mapping Embodiment

The EWD Integrated with Mapping embodiment provides a method and system that helps dealers properly distribute workload for technicians of the dealers based on data and the statistics of the dealerships stored in a database (e.g., the “Worldstats and Dealerstats” database/tables available from Business Equipment Information—BEI—Services, Inc.). The database is stored on a computer readable medium accessible by the computer system implementing an embodiment. An embodiment may create boundary-less territories based on machine populations, model types, segment levels, CPMH (Copies Per Maintenance Hour) and technicians weighted FCE (First Call Effectiveness) performance for machines encompassed in a geographic area of interest. For some embodiments, the geographic area of interest may be a sample, or test, service territory laid out on a map using boundaries drawn on the map by a user. A user may grow the sample/test service territories dynamically and see the service technicians best suited for each of the areas displayed. Using a variety of calculations (described in more detail below) combined together, a user may create an Effective Workload Distribution for each service technician. After a service technician has been assigned to a territory, mapping software incorporated into an embodiment may create an exportable equipment to service technician assignment file that may be imported into an ERP (Enterprise Resource Planning) system for automatic reassignment of service technicians to particular machines. The mapping feature of an embodiment may also allow the provider of an embodiment (e.g., BEI Services, Inc.) to monitor, manage and benchmark each service territory on a monthly basis (or other periodic basis as desired by the embodiment provider and the purchaser/customer of the embodiment) and warn the purchasers/customers when service technician service areas are getting out of alignment (aka. Territory Integrity). With equipment and service technicians assigned in each service territory, an embodiment may create a parts car stock requirement using information on parts usage statistics for each serviceable unit model/type both from information provided by the dealers and information obtained from the database accessible to an embodiment (e.g., the “Worldstats and Dealerstats” database/tables available from BEI Services, Inc.).

Conceptually, EWD (Effective Workload Distribution) for an embodiment selects the service technicians a user wants to assign to a Work Area and then the type of equipment the user wants the chosen/selected service technicians to work on. In an integrated mapping portion of an embodiment, a user may select a Work Area (i.e., a graphical area of interest) and the mapping program will send the geographic area selection information or “boundary” from the Work Area created to a computing system (e.g., a general purpose computer system performing the tasks of an embodiment). The database may send the mapping portion of an embodiment the geographic data codes for the type of equipment selected for the selected geographic Work Area. At this point an embodiment has the equipment requested to be worked on and the service technicians that will be assigned to selected equipment. Within the Work Area created, an embodiment may now create EWD territories for each of the service technicians chosen. If an embodiment detects matching geographic data codes for different customers, additional customer information needs to be sent to the mapping portion of an embodiment for display purposes for a “Multiple Customer” feature.

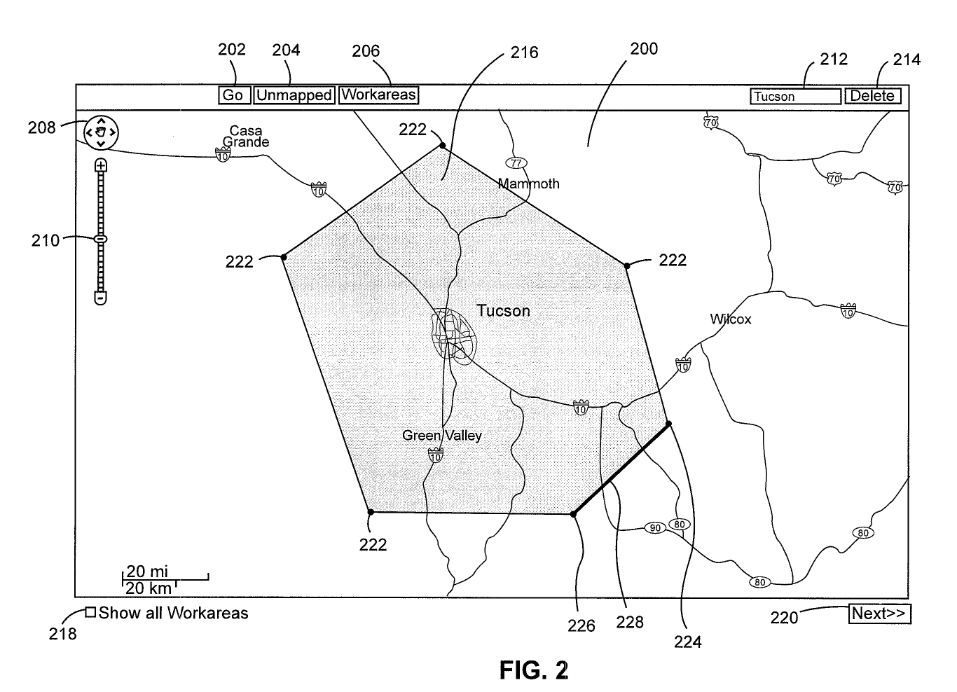

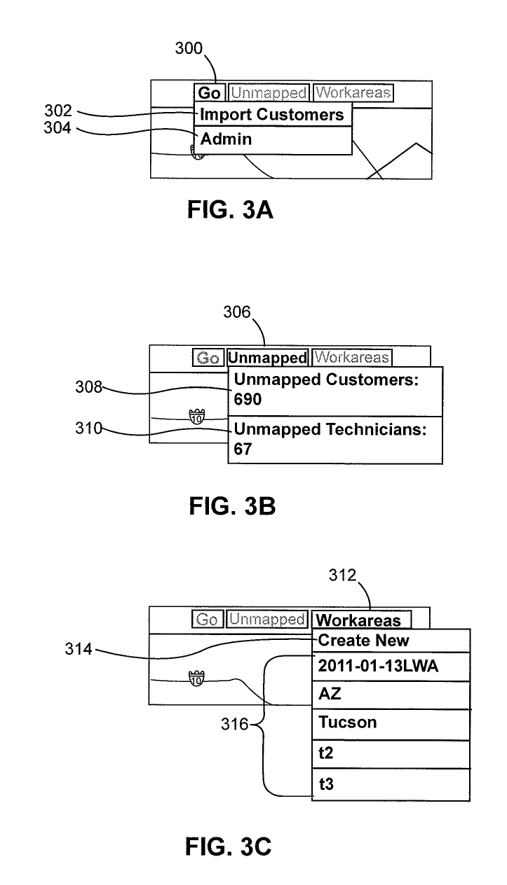

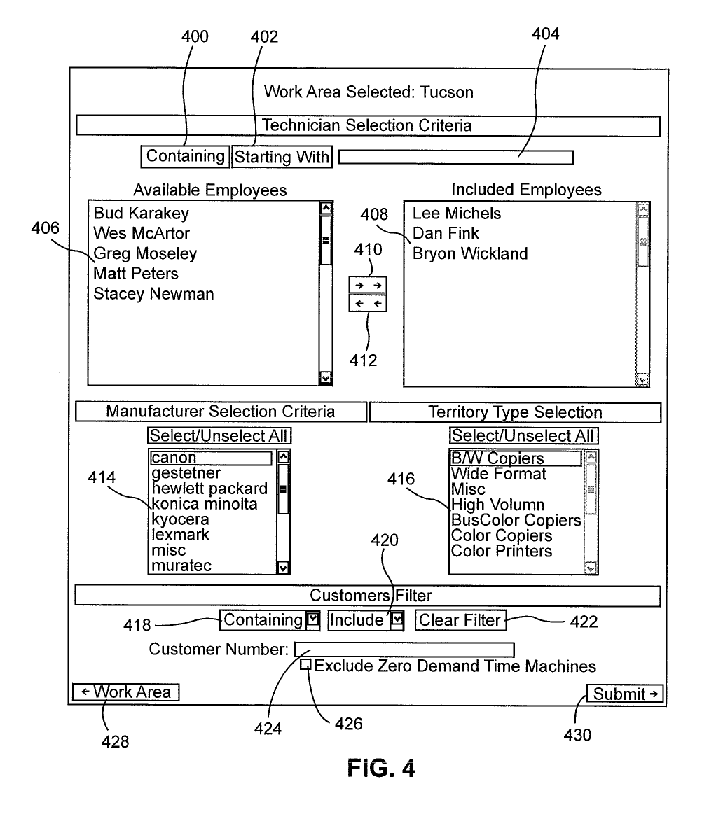

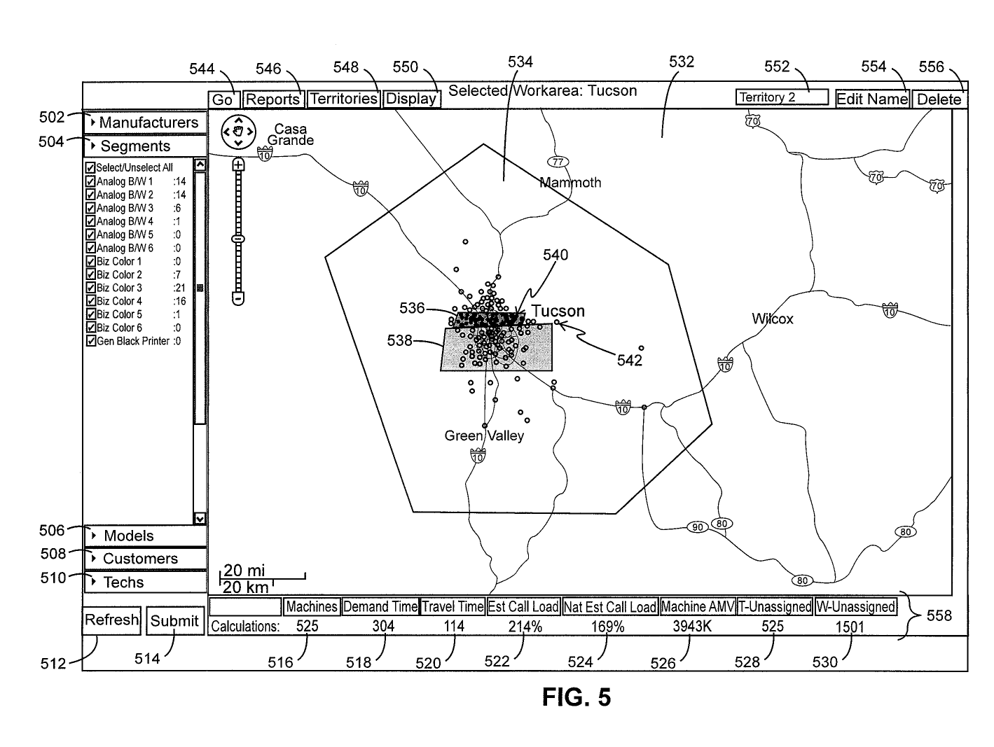

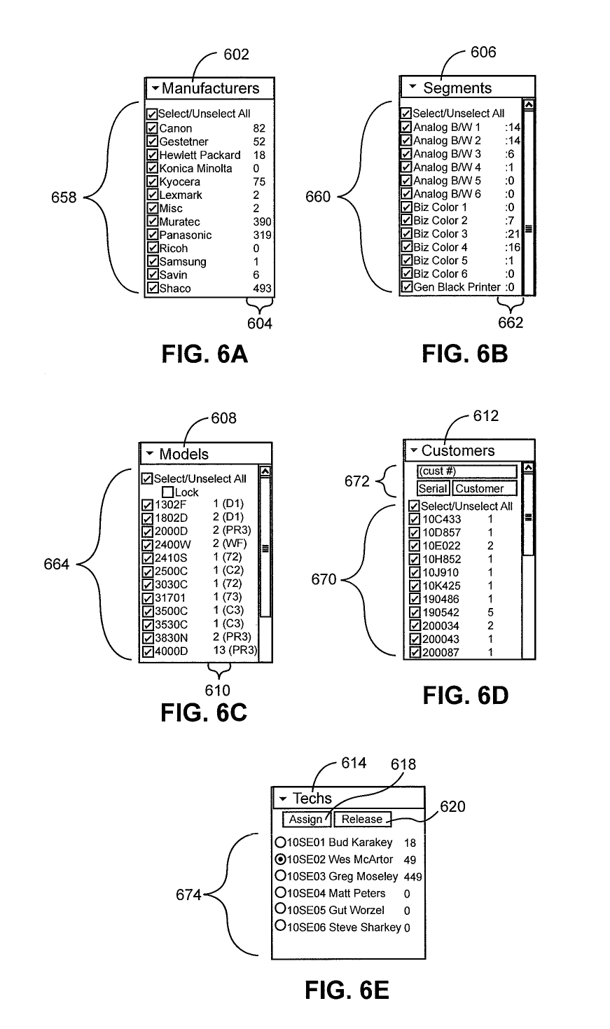

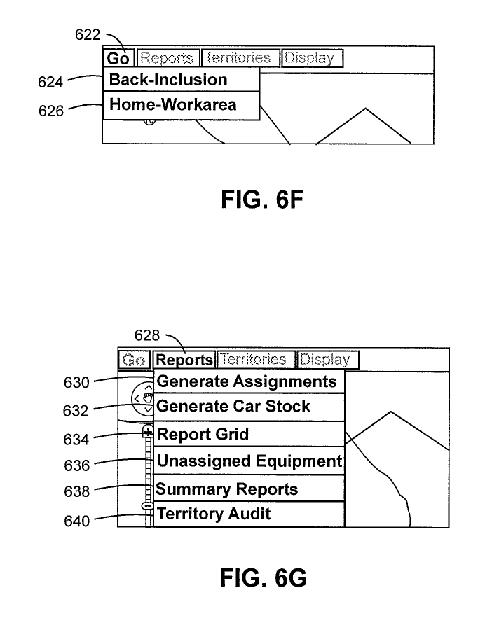

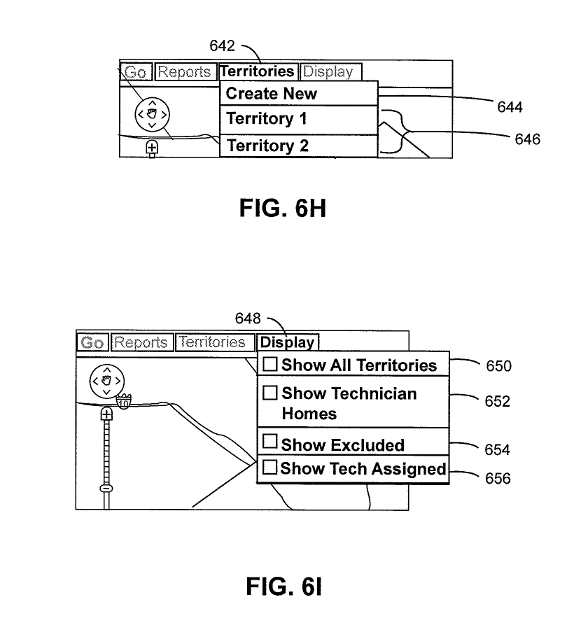

There are four primary features in the mapping integrated embodiment discussed above:
1) The database (e.g., the “Worldstats and Dealerstats” database/tables available from BEI Services)
2) The Work Area page (see FIGS. 2 and 3A-C)
3) An inclusion page/feature (see FIG. 4)
4) Territory Page—software capable of multi-layer geographical selections for territory creation and maintenance (see FIGS. 5 and 6A-I)

The Database (e.g., BEI “Worldstats and Dealerstats” Database/Tables)

A database, such as the “Worldstats” database/table from BEI Services, Inc., that maintains known imaging systems as the imaging systems (e.g., a copier) relates to device and service technician performance measurements. A large database is desirable and the BEI Services, Inc. “Worldstats” database/table works well for various embodiments. The “Worldstats” database/table currently has more than 1.2 billion database entries consisting of data on more than 71,000 service technicians doing more that 1,100,000 service calls on more than 7.55 million imaging devices monthly.

An embodiment may also benefit from some unique national machine and service benchmarks provided by the BEI “Worldstats” database/table from BEI Services, Inc., and used throughout the imaging industry. The combined data is known as “Worldstats,” and may include data indicating which imaging devices are measured against for CPC/CPP (cost per copy)/(cost per print) for both parts and labor costs.

A few of the unique measurements provided by an embodiment's data may include, but are not limited to:
Machine Demand Time: This relates to the service demand time of the machine based in segment levels, and the measurement length of time as it relates to the segments. This is based on all service calls inclusive of all technicians who worked on the device. This measurement is the expected amount of service time required to maintain this device at the device's current performance level.
BEI Call Back Criteria (BEICBC): Since all manufactures and models are not created equal and do not perform equally, the BEICBC established the best call back criteria created in the imaging industry. Using the BEI “Worldstats” database/table; the national average for each model based on the number of copies and days between service call visits is found. Fifty percent (50%) for each of national average values is then used to create the call back standard. EXAMLPE—If, on average, a model of machine goes 10,000 copies/prints and 30 days between visits, then an effective service call would be if the machine reached either 5,000 copies OR 15 days. If the machine reaches this benchmark it is an effective service call, if not, it is considered a poor service call and a “callback” service call.
National Call Back First Call Effectiveness (NCBFCE): Based on the NCBC, if the service technician achieves the NCBC benchmark the service technician would have a 100% First Call Effectiveness, if not a 0% effectiveness. Applied over time and serviceable unit models a NCBFCE may be established on a per service technician and machine basis. In addition, the NCBFCE is also based on the number of times a service technician is required to return to the customer site (i.e., return to the serviceable unit) because the service technician did not have the necessary parts.
Copies per Maintenance Hour: This is the number of copies/prints produced per maintenance hour for an individual service technician. This is a model based measurement.
Technician Demand Time: This is the amount of time on average it would take to produce the same amount of copies/prints based on this individual technician's performance for the same machines as measured in “Machine Demand Time”.
Territory Integrity: This measurement is used to ensure the assigned service territory is working as planned. In a successful territory, the assigned service technician should do at least 85% of calls the technician is assigned to. Should the territory integrity number fall below 85%, it is an indication that the territory is too big and the service technician is requiring the assistance of other technicians to maintain an appropriate response time. If, the assigned technician works on machines other than those assigned in excess of 15%, this indicates the assigned territory is too small and can be increased. Demand time can also indicate the integrity of the territory. If a significant number of machines are added to or removed from the territory, the amount of demand will change triggering a territory integrity alert.

An embodiment may automate territory alignment based on:
A display of copier and printer locations using a variety of inclusion and exclusion filters of the equipment on a map while allowing the mapping capabilities to encompass and calculate machine demand dynamically, and then assigning a service technician to the encompassed territory and seeing the effects of demand time based on the technician's personal performance.
Calculations of a technician's demand time based on performance (see below).
Territory Integrity monitoring (see below).
Some desirable features for an embodiment are to utilize a web based mapping program that allows a user to do the following:
Gather geographic coordinates from addresses.
Plot geographic coordinate locations on a map.
Create variable shapes and sizes on a map encompassing geographic areas via

API's (Application Programmer Interfaces) that allow you to surround and identify plotted locations.

After the machines encompassed within a border are identified, an embodiment may use underlying database calculations to create needed service territories. For various embodiments, custom javascript, not a mapping API, may be used to:
interact with mapping APIs for geographic coordinates and polygons.
activate polygons, filters, and selection criteria.
determine which geographic coordinates fall within a polygon.
interact with backend servers to submit and parse data.
   Beneficial Custom server software may include, but is not limited to:
creating custom calculations based on requests from the user.
providing data back to the client setting the service territories.

Work Area Page (See FIGS. 2 and 3A-C)

FIG. 2 is a schematic illustration of the “Work Area” page of a user interface of an embodiment that may be used as a “start” (i.e., initial/opening) page for an embodiment, that permits a user to select the initial geographic area (i.e., “work area”) 216 in which serviceable units are to be included, and that may also allow a user access to other areas via control dropdown menus 202-206 (see also the disclosure with respect to FIGS. 3A-C below). For an embodiment, the Work Area page may be the initial page of entry when a user is directed to an embodiment from a main/other provider website (e.g., BEI Services main website). The redirection may occur, for example, when a user selects “Territory Mapping” at the main provider website. The Work Area page may automatically load and populate a map 200 centered on an area based on GEO codes (i.e., geographic codes) associated with a user selected address, such as the address of the service facility associated with a particular user. GEO codes are latitude and longitude coordinates (or other geographic coordinate system) of a physical address plotted on a map as a location marker. The core mapping area/map 200 and basic mapping functionality (movement 208 and zoom control 210) for an embodiment may be created solely for an embodiment, and/or may be provided by a third party system such as Google maps. For an embodiment, using the Work Area page users may create the initial geographic areas (i.e., work areas) 216 that may eventually be subdivided into service territories for the service technicians via creation of the service territories within the initial geographic areas/work areas 216. An embodiment may limit a user to a single work area, or an embodiment may permit a user to create multiple work areas 216. To create a work area 216, a user may place plotting markers 222-226 on the map 200 using a computer mouse to place the markers 222-226. When the last plotting marker 226 is attached to the first plotting marker 224, the work area 216 is closed 228 and may be created and named. Some features of the Work Area page of the embodiment shown in FIG. 2 are:
Mapping area (200): The map area where users encompass/create the initial geographical areas 216 in which the users desire to work within.
Go dropdown menu (202—see also the disclosure with respect to FIG. 3A): The “Go” button/control 202 provides a dropdown menu that may allow users to navigate to an import page to import addresses for GEO Coding, and/or to navigate to an Admin page for administration purposes.
Unmapped dropdown menu (204—see also the disclosure with respect to FIG. 3B): The “Unmapped” button/control 204 provides a dropdown menu that may allow users to view a count of addresses not GEO coded for particular customers and/or technicians, and/or to navigate to an area to correct customers/users not properly GEO coded.
Workareas dropdown menu (206—see also the disclosure with respect to FIG. 3C): The “Workareas” button/control 206 provides a dropdown menu that may allow a user to select to create new initial geographic areas 216, and/or to select other initial geographic areas 216 already created.
Mapping navigation (208): Buttons/controls that allow a user to move around (e.g., up/down and left/right) on the mapping area 200.
Mapping zoom (210): Buttons/controls that allow a user to zoom in and out of the mapping area 200.
Naming box (212): A data entry control/location to name a Work Area 216 created using the Work Area page.
Delete (214): A button/control that deletes the Work Area designated in the naming box 212.
Defined Work Area (216): The active initial geographic area 216 being created.
Show all Workareas checkbox (218): A checkbox control that, when checked, permits an embodiment to show all created work areas 216 that are in the displayed mapping area 200, and when unchecked only displays the current work area 216 being created or edited that is designated in the naming box 212.
Next button (220): A button/control that when clicked/activated redirects/takes a user you to an “Inclusion” page.

FIG. 3A is a schematic illustration of the Work Area page user control menu 302, 304 for the “Go” control/button 300 on the Work Area page that permits a user to navigate to other pages/areas for an embodiment. For the embodiment shown in FIG. 3A, when the Go button/control 300 is clicked on/activated, the dropdown menu with entries “Import Customers” 302 and “Admin” 304 is invoked. By clicking on/activating the Import Customers menu item 302, a user may be redirected to an import page for importing addresses for GEO coding. By clicking on/activating the Admin menu item 304, a user may be redirected to an administration page for performing administration functions.

FIG. 3B is a schematic illustration of the Work Area page user control menu 308, 310 for the “Unmapped” control/button 306 on the Work Area page that permits a user to navigate to other pages/areas for an embodiment. For the embodiment shown in FIG. 3B, when the Unmapped button/control 306 is clicked on/activated, the dropdown menu with entries “Unmapped Customers” 308 and “Unmapped Technicians” 310 is invoked. The number of unmapped customers may be shown on the Unmapped Customers menu item 308 (i.e., 690 unmapped customers in the embodiment shown in FIG. 3B) and the number of unmapped technicians may be shown on the Unmapped Technicians menu item 310 (i.e., 67 unmapped technicians in the embodiment shown in FIG. 3B). By clicking on/activating the Unmapped Customers menu item 308, a user may be redirected (i.e., navigate) to a page for correcting unmapped customers. By clicking on/activating the Unmapped Technicians menu item 310, a user may be redirected (i.e., navigate) to a page for correcting unmapped technicians.

FIG. 3C is a schematic illustration of the Work Area page user control menu 314, 316 for the “Workareas” control/button 312 on the Work Area page that permits a user to navigate to other pages/areas and/or listings of work areas created for an embodiment. For the embodiment shown in FIG. 3C, when the Workareas button/control 312 is clicked on/activated, the dropdown menu with entries “Create New” 314 and menu items for a variety of previously created work areas 316 is invoked. By clicking on/activating the Create New menu item 314, a user may be permitted to operate the mapping area (item 200 in FIG. 2) and to create a new work area (item 216 in FIG. 2) by placing markers (222-226 in FIG. 2) to encompass the desired new work area (item 216 in FIG. 2). By clicking on/activating one of the menu items 316 for previously created work areas (item 216 in FIG. 2), a user may be permitted to view, change, and/or delete the selected previously created work area (item 216 in FIG. 2).

Inclusion Page/Feature (see FIG. 4)

FIG. 4 is a schematic illustration of an “inclusion” page for selecting which serviceable equipment types of units, customers and technicians to include and/or exclude from a service territory for an embodiment. The “Inclusion” page/feature of an embodiment may be utilized to display data regarding the serviceable unit equipment types and/or the service technicians that may be included in the work area in the Mapping Feature (see also the disclosure with regard to FIGS. 5 and 6A-I). The following descriptions define the controls/usage for the embodiment shown in FIG. 4.
Containing Button (400): A button/control that toggles on/off when clicked on/activated to indicate that the technician filter data entry 404 filters the available technicians (aka. employees) 406 to include only those technicians that “contain” the data in the technician filter data entry 404. An embodiment may pair the Containing button/control 400 with the Starting With button/control 402 such that only one of the buttons 400, 402 is selectable at one time.
Starting With Button (402): A button/control that toggles on/off when clicked on/activated to indicate that the technician filter data entry 404 filters the Technician list box (aka. Available Employees) 406 to include only those technicians that “start with” the data in the technician filter data entry 404. An embodiment may pair the Starting With button/control 402 with the Containing button/control 400 such that only one of the buttons 400, 402 is selectable at one time.
Technician Filter (404): A data entry field for entering the filter data used to filter the technicians shown in the Technician list box (aka. Available Employees) 406 such that only technicians meeting the criteria of the entered filter data (as combined with the on/off status of the Containing 400 and Starting With 402 buttons) are displayed in the Technician list box (aka. Available Employees) 406.
Technician List Box (aka. Available Employees) (404): A list box control that displays the currently available (i.e., not included) service technicians in for a company/organization for a work area. The list may be filtered as described above with regard to the Containing button 400, Starting With button 402, and Technician Filter data entry field 404. One skilled in the art will recognize that other filters may also be applied to the Technician list box (aka. Available Employees) 406, such as distance of the technician/employee from a location, expertise with particular equipment, certifications, etc. When a service technician/employee is moved to the Included Employee/Technician list box 406, the moved service technician/employee is removed from the Technician list box (aka. Available Employees) 406.
Included Employees/Technicians List Box (408): A list box control that displays the service technicians/employees used/included in the current EWD (i.e., service technician territory) assignment. When a service technician/employee is moved back to the Technician list box (aka. Available Employees) 406, the moved service technician/employee is removed from the Included Employees/Technicians list box 408.
Move to Included Button (410): A button that, when clicked on/activated, causes the currently selected one or more employees/technicians in the Technician list box (aka. Available Employees) 406 to be moved to the Included Employees/Technicians list box 408. One skilled in the art will recognize that other methods of selecting and moving items from one list box to another may be used in replacement of or in addition to the Move to Included button 410, including a drag-and-drop capability.
Move to Available Button (412): A button that, when clicked on/activated, causes the currently selected one or more employees/technicians in the Included Employees/Technicians list box 408 to be moved to the Technician list box (aka. Available Employees) 406. One skilled in the art will again recognize that other methods of selecting and moving items from one list box to another may be used in replacement of or in addition to the Move to Included button 410, including a drag-and-drop capability.
Manufacture List Box (414): A list box control that lists all available equipment manufacturers and permits a user to select (i.e., highlight) one or more equipment manufacturers from the list. One skilled in the art will recognize that other types of controls, such as a combined checkbox/list box, may be used in an equivalent manner.
Territory Type List Box (416): A list box control that lists the available equipment types that may be shown within a work area and permits a user to select (i.e., highlight) one or more equipment types from the list. Again, one skilled in the art will recognize that other types of controls, such as a combined checkbox/list box, may be used in an equivalent manner. If all equipment types are selected, an embodiment may show a broad selection of equipment types within a work area. Various embodiments may default to select all equipment types in the list. For the example of a copier/printer repair service company, the equipment types (i.e., data) shown in the Territory Type list box 416 may be divided into groups of equipment types such as copiers, printers, and miscellaneous. More detailed selections may be made when defining service territories (see the disclosure with respect to FIGS. 5 and 6A-I).
Customer Filters (418-424): The customer filters 418-424 permits a user to filter the customers using various criteria. For instance, the include/exclude selector 420 may permit a user to include or exclude customers based on the defined criteria. The containing/starting with selector 418 may permit a user to define whether the criteria data in the customer number data field 424 should be evaluated for the filter of customers as customer data simply containing the data in the customer number data field 424 or only if the customer data starts with the data in the customer number data field 424. The clear filter button 422 clears any filtering currently being implemented.
Exclude Zero Demand Time Machines (426): Due to the nature an embodiment using calculations of equipment demand time to create a work month for a technician, the process may only go back as far as 18 months for service calls and demand time since infinite historical data is not possible and there might be real world storage limits on how long historical data may be kept (for the example embodiment herein, that time frame is assumed to be 18 months). Thus, equipment not serviced in the last 18 months may not have any demand associated with the equipment (i.e., zero demand equipment). A zero demand unit of equipment may be permitted to be excluded from the calculations for a territory assignment so the equipment will not be assigned to a service technician since the zero demand equipment has historically not required any service calls.
Workarea Button (428): A button that when clicked on/activated redirects a user back to the Workarea page (see the disclosure with respect to FIGS. 2 and 3A-C).
Submit Button (430): A button that when clicked on/activated submits the above described selections and redirects the user back to the next page in the territory assignment process, such as the Territory page of the embodiment described in the disclosure below with respect to FIGS. 5 and 6A-I.

Territory Page/Feature (See FIGS. 5 and 6A-I)

FIG. 5 is a schematic illustration of territory page/feature that provides an interface for creating, viewing and editing technician territories within a work area (see, for example, the disclosure with respect to FIGS. 2 and 3A-C) for an embodiment. FIGS. 6A-I, which will be discussed concurrently with FIG. 5 below) are schematic illustrations of the drop-down menus and other details invoked/activated by clicking on/activating various buttons and/or other controls on the Territory Page. An embodiment may include a number of layers used in mapping that may allow an embodiment to import the data needed to perform the required territory suggestions. As with the Work Area page discussed above with respect to FIGS. 2 and 3A-C, the core mapping area/map 532 and basic mapping functionality (such as movement and zoom control) for an embodiment may be created solely for an embodiment, and/or may be provided by a third party system such as Google maps. The Territory Page/feature may also contain the information associated with the selection criteria for machines (i.e., serviceable units) and service technicians, as well as the calculations from the territories being configured. The following items may be included on a Territory page:
Manufacturers Accordion Dropdown Selector List (502/602): A combined checkbox/list box accordion dropdown list of the types of manufacturers that may be included on the Territory page (FIG. 5). FIG. 6A is a schematic illustration of the Manufacturers accordion dropdown selector list 502/602 showing a list of potential manufacturers 658 for an embodiment. The Manufacturers accordion dropdown selector list 502/602 may permit a user to select which manufactures they would like to include in the populations 540, 542 on the Territory page (FIG. 5). The number 604 next to each listed manufacturer 658 may be used in an embodiment to specify how many devices there are for each associated manufacturer 658 listed in either the work area 534 or the selected territory 536, 538. The initial checkbox configuration was made from the inclusion page (see, for example FIG. 4, Item 414)
Segments Accordion Dropdown Selector List (504/606): A combined checkbox/list box accordion dropdown list of the segments (i.e., groupings of types of models) that may be included on the Territory page (FIG. 5). FIG. 6B is a schematic illustration of the Segments accordion dropdown selector list 504/606 showing a list of potential segments 660 for an embodiment. The Segments accordion dropdown selector list 504/606 may permit a user to select which segments they would like to include in the populations 540, 542 on the Territory page (FIG. 5). The number 662 next to each listed segment 660 may be used in an embodiment to specify how many devices there are for each associated segment 660 listed. When a work area 534 is first created, the total population 540, 542 in each segment 660 selected from the Manufacturer (414 on FIG. 4) and Territory Type (416 on FIG. 4) of the Inclusion page (FIG. 4) will be displayed. When a territory 536, 538 is being created, the segment counts area 662 may be cleared and the dynamically updated count 662 may then reflect the count of segments of unassigned devices in the selected territory 536, 538 at that time. The initial checkbox configuration was made from the inclusion page (see FIG. 4, Item 416)
Models Accordion Dropdown Selector List (506/608): A combined checkbox/list box accordion dropdown list of the particular equipment models that may be included on the Territory page (FIG. 5). FIG. 6C is a schematic illustration of the Models accordion dropdown selector list 506/608 showing a list of potential models 660 for an embodiment. The Models accordion dropdown selector list 506/608 may permit a user to select which segments they would like to include in the populations 540, 542 on the Territory page (FIG. 5). The number 610 next to each listed model 664 may be used in an embodiment to specify how many devices there are for each associated model 664 listed. When a work area 534 is first created, the total population 540, 542 for each selected model 664 will be displayed. When a territory 536, 538 is being created, the model counts area 664 may be cleared and the dynamically updated count 664 may then reflect the count of models in the selected territory 536, 538 at that time. Using the checkboxes in the list of models 664, a user may include and/or exclude models in a similar fashion to the other checkbox/list boxes discussed herein. The lock box 668 allows the user to maintain the selection while creating other territories 536, 538. If the lock box 668 is not selected, then all models 664 populate when the user selects Create New territory 644 (FIG. 6H). Initially, the count 610 of the models 664 in the work area 534 may be displayed. When a territory is created 536, 538, the count 610 may reflect the model count in the newly created territory 536, 538.
Customers Accordion Dropdown Selector List (508/612): A combined checkbox/list box accordion dropdown list of the potential customers with equipment in a work area 532/territory 536, 538. FIG. 6D is a schematic illustration of the Customers accordion dropdown selector list 508/612 showing a list of customers 670 with equipment in a work area 532/territory 536, 538. The Customers accordion dropdown selector list 508/612 may permit a user to select and/or deselect which customers 670 are assigned to a territory 536, 538 (i.e., assigned to a technician 510 associated with the territory 536, 538) that the user would like to assign to the territory 536, 538/technician 510. When a territory 536, 538 is first created for a technician 510, an embodiment may default that all customers are selected, and then require a user to deselect any customers not desired to be associated with the technician 510 associated with the territory 536, 538. Also, an embodiment may give customer information in the customer information area 672 when the mouse cursor is hovered over or clicked on a customer number 670. Various embodiments may also permit a user to search for a customer by the customer number 670 or the serial number of particular equipment units/devices.
Techs (Technicians) Accordion Dropdown Selector List (510/614): A combined radio button/list box accordion dropdown list of the available technicians to assign to a selected territory 536, 538. FIG. 6E is a schematic illustration of the Technicians accordion dropdown selector list 510/614 showing a list of available technicians 674 that may be assigned to a territory 536, 538. For various embodiments, when a technician 674 is selected by clicking the radio button associated with the technician 674 the Estimated Call Load 522 and/or other data in the territory calculations 558 dependent on the selected technician 674 may be dynamically changed based on the selected technician's 674 performance on the particular equipment models 506/608 within the selected territory 536, 538. The Estimated Call Load calculation 522 is based on the selected technician's 674 Copies Per Maintenance Hour (CPMH) that may be derived from a historical data such as BEI's “Dealerstats” database/table of the technician's work history. An embodiment may permit a user to experiment with different technicians 674 for a territory 536, 538 without actually assigning the territory to the technician until the user clicks on/activates the Assign button 618. Similarly, a user may not be officially removed from a territory until the user clicks on/activates the Release button 620.
Territory Calculations (558): An information display area on the Territory page (FIG. 5) that may display current information on a selected service territory 536, 538 and may be dynamically updated as manufacturers 502/602, segments 504/606, models 506/608, customers 508/612, and/or the assigned technician 510/614 is changed for the selected territory 536, 538 a user is working on at the current time. For instance, when a user selects a service technician 674 from the Technicians list 510/614 and assigns 618 the selected service technician 674 to the selected territory 536, 538, the territory calculations 558 may update the pertinent information using the service technician's 674 historical statistics, both weighted and not (e.g., the statistics obtained about the technician from a BEI “Dealerstats” database/table). The following is a list of calculations for the embodiment shown in FIG. 5. The calculations may also populate the Models list 506/608 with all the models the service technician 674 is capable of working on when a service technician is selected 674.
   Machines (516): The number of machines in a selected territory 536, 538. The machines count value 516 may grow or shrink dynamically as the territory is increased or decreased in size. The machine count value 516 may also be used for the estimation of the call load of machines/equipment units for a company as well as nationally based on machine/equipment unit averages.
   Demand Time (518): The total amount of time (typically in hours) that has been historically determined to be required for servicing the currently selected serviceable unit devices within the active territory 536, 538. For an embodiment, each serviceable unit device's demand time may be based on a three month custom report, and may further be obtained by taking the average maintenance time of a device (avg_mt) and multiplying it by the total calls for a device in the last three months. To obtain a device's monthly demand time average, from the three month report, divide the three month result by three.
   Travel Time (520): The amount of travel time (typically in hours) that may be included in the demand time 518 discussed above.
   Estimated Call Load (522): The estimated call load of the work area 534, or a selected territory 536, 538, based on the average demand time of the devices selected. For various embodiments, on the initial entry into the Territory page (FIG. 5), the calculations will be based on all devices populated within the current work area 534. When a territory 536, 538 is selected/created, the calculations may then reflect the subset of devices in the selected territory 536, 538. When a technician is selected from the technician list 510/614 the estimated call load 522 may then be based on the selected technician's 674 performance. For an embodiment, the estimated call load 522 may be the percentage of the demand time divided by 143 hours (100%=143 hours or some other number of hours determined to be a full load for a technician). In the initial creation of the territory 536, 538, the estimated call load 522 may be based on the average workload for the machines in the selected territory 536, 538. When a technician 674 is selected, the estimated call load 522 may change because the selected technician's 674 individual performance on each equipment unit model in the territory 536, 538 may then be dynamically taken into consideration. The combined Average Monthly Volume (AMV) (see also the disclosure with respect to item 526 below) of each model may be totaled and then divided by the technician's CPMH for those models to calculate the new estimated call load percentage. FIG. 10 is a simple explanation of this calculation.
   Nat Call Load (524): The percentage of the call load based on national statistics (e.g., the statistics obtained about the technician from a BEI “Worldstats” database/table) of the models demand time, which may be divided by 143 hours (or other full time hours determined for technicians) for the example embodiment discussed with regard to the estimated call load 522 calculation described above.
   Average Machine Volume (aka. Machine AMV) (526): The combined/aggregated total of the monthly AMV (Average Machine Volume) for the selected machines (i.e., the machines in the selected territory 536, 538).
   T-Unassigned (aka. Territory Unassigned) (528): The number of serviceable machines in the active territory not assigned to a technician 510/614 due to the included/excluded models on the Model list 506/608.
   W-Unassigned (aka. Work area Unassigned) (530):—The total number of machines in the entire active work area 534 not assigned to a service technician 510/614.
Go Button (544/622): The “Go” button/control 544/622 provides a dropdown menu that may allow users to navigate to other pages. FIG. 6F is a schematic illustration of the Territory page user control menu 624, 626 for the “Go” button/control 544/622 on the Territory page (FIG. 5) that permits a user to navigate to other pages/areas for an embodiment. When the Go button/control 544/622 is clicked on/activated, the dropdown menu with entries “Back-Inclusion” 624 and “Home-Workarea” 626 may be invoked. By clicking on/activating the Back-Inclusion menu item 624, a user may be redirected back to the previous Inclusion page (FIG. 4). By clicking on/activating the Home-Workarea menu item 626, a user may be redirected to the Work Area page (FIG. 2).
Reports Button (546/628): The “Reports” button/control 546/628 provides a dropdown menu that may allow users to access a variety of different reports. FIG. 6G is a schematic illustration of the Territory page user control menu 630-640 for the “Reports” button/control 546/628 on the Territory page (FIG. 5) that permits a user to create and view the report associated with a selected menu item 630-640 for an embodiment. Some potential reports/menu items 630-640 may include, but are not limited to, the following:
   Generate Assignments (630): Creates a Comma Separated Variable (CSV) file for the selected technician 510/614 (i.e., the technician 510/614 assigned to a territory 536, 538) describing a technician to device assignment that may be used to import into other software, such as Enterprise Resource Planning (ERP) systems.
   Generate Car Stock (632): Creates a CSV file of suggested car stock a technician 510/614 should carry to manage a selected territory 536, 538.
   Report Grid (634): Generates a CSV file of each model 506/608 and the count of the model 506/608 assigned to technicians 510/614.
   Unassigned Equipment (636): Generates a CSV file of unassigned equipment/devices.
   Summary Reports (638): Generates a CSV file of each territory's 536, 538 information that may include, but is not limited to: Territory Name, Assigned Technician, Machine Count, Average Monthly Volume, Demand Time, Travel Time and Estimated Call Load percentage.
   Territory Audit (640): Generates an active matrix window that allows you to see models 506/608 assigned to the technicians 510/614 and each technician's 510/614 individual performance on each model 506/608 measured in Mean Copies/Prints Between Visits (MCBV) and first Call Effectiveness (FCE %). The Territory Audit 640 active matrix window may further allow a user to display machine/device locations of the models 506/608 and unassign the models 506/608 from a technician 510/614 if desired.
Territories Button (548/642): The “Territories” button/control 548/642 provides a dropdown menu for managing territories 536, 538. FIG. 6H is a schematic illustration of the Territory page user control menu 644, 646 for the “Territories” button/control 548/642 on the Territory page (FIG. 5) that permits a user to create a new territory 536, 538 or select an already created territory 536, 538 in a work area 534 for an embodiment. By clicking on/activating the Create New menu item 644, a user may start the process for creating a new territory 536, 538. The remaining menu items 646 may be used to select an already created territory (e.g., Territory 1 may correspond to item 536 on FIG. 5 and Territory 2 may correspond to item 538 on FIG. 5).
Display Button (550/648): The “Display” button/control 550/648 provides a combined checkbox dropdown menu for managing whether or not various items are displayed on the Territory page (FIG. 5). FIG. 61 is a schematic illustration of the Territory page user control menu 650-656 for the “Display” button/control 550/648 on the Territory page (FIG. 5) that permits a user to manage whether or not various items are displayed on the Territory page (FIG. 5) for an embodiment. When a checkbox for a menu item 650-656 is checked, the associated items may be displayed on the Territories page (FIG. 5) and, when unchecked, the associated items may not be displayed on the Territories page (FIG. 5). Some display options/menu items 650-656 may include, but are not limited to the following:
   Show All Territories (650): When checked, displays all assigned territories 536, 538.
   Show Technician Homes (652): When checked, displays the service technician's 510/614 home location.
   Show Excluded (654): When checked, displays all serviceable equipment in the active territory 536, 538 that may have been is excluded based on the Model selection menu 506/508. Excluded serviceable units may populate as a different color and may act essentially as removal of machine display filters. Thus, displayed equipment units 540, 542 may be shown in two colors such that one color (for instance those like 540) may indicate included equipment units and the other color (for instance those like 542) may indicate excluded equipment units.
   Show Tech Assigned (656): When checked, the technician assigned to a territory may be displayed on in association with the appropriate territory 536, 538 on the Territory page (FIG. 5).
Territories Name data entry field (552): A data entry field that displays, and permits a user to change, the name of the currently selected territory 536, 538.
Edit Name Button (554): A button that when clicked on/activated changes the stored name for the currently selected territory 536, 538 to the name in the Territories Name data entry field 552.
Delete (Territory) Button (556): A button that when clicked on/activated deletes the currently selected territory 536, 538.
Territory Page (FIG. 5)—The mapping area 532 provides the primary mapping capabilities of the system. The work area 534 is the created work area created on the Work Area page (FIG. 2) as described in the disclosure with respect to FIG. 2 above. Within the work area 534 boundaries, location markers 540, 542 of the non-filtered GEO coded customers may be populated on the map. These location markers 540, 542 may contain single or multiple customers and/or single or multiple devices. An embodiment may create territories based on the location markers 540, 542. The territories 536, 538 may then be created within the selected work area 534. A format for display of serviceable units 540, 542 may provide different colors for a variety of factors such as assigned/unassigned to a technician, model type, owning customer, etc. A further format of the display of the serviceable units 540, 542 may place a dot with a number inside different than machines that are excluded or unassigned. The number inside the dot may specify the number of machines at the same address/geographic code for a single customer based on customer number. An indication a technicians' home addresses may also be shown, perhaps as a small icon of a house with the technician's name on it, based on a selection made in the Inclusion Page (FIG. 4). As part of the general mapping area 532, there may be two potential layers, as follows:
   Work Area (534): Area where the serviceable equipment units 540, 542 are populated initially based on the “initial” polygon selection of the work area 534 created as described above for FIG. 2. Data outside of the work area 534, except technicians' homes, may not be displayed.
   Territories (536, 538): Area that designates the geographic area assignment for a service technician. The territories 536, 538 define the areas the calculations 558 will be based on. By providing the ability to make flexible shapes, territories 536, 538 may create areas around the location markers 540. 542 containing the machines/serviceable equipment desired to be chosen. As the territory areas 536, 538 increase or decrease during the selections, the calculations in the Territory Calculations 558 dynamically update to reflect the selected technician and the serviceable units in the selected territory 536, 538. Once a territory area 536, 538 has been created, an available technician 510/614 may be selected for the active territory 536, 538 by selecting the technician 674 and clicking the assign button 618. Upon assignment, the location markers 540, 542 may disappear from the map 532/work area 534. To unassign a technician 674 from a territory 536, 538, the user may click on the release button 620. Units in the active territory may displayed in one color, such as blue circles 540, while the inactive territories are displayed differently, such as outlined shapes with either red circles or no circles. Further, for an embodiment, no circles may indicate equipment units/machines in a territory 536, 538 are assigned.

Note that for various embodiments one skilled in the art may change the type/style of controls implementing features while maintaining similar functionality as desired by a system designer/creator. One skilled in the art may also recognize that the count values associated with the various lists for various embodiments may be dynamically updated to reflect the currently active territory 536, 538 or the overall work area 534, and/or a combined number may be shown giving both territory 536, 538 and overall work area 534 counts.

Territory Integrity Feature

Territory Integrity is a feature that may be run periodically (e.g., every month), often coinciding with when a host processes a customer's data. For an embodiment, territory integrity may incorporate three checks to validate the integrity of a service technician's territory.
The first check may be the check of demand time based on a technician's demand time set when the territory was assigned and the variance thereof For example, if a technician is set up with a monthly demand time of 143 hours and the technician exceeds or falls behind this set demand time by X hours a notification/alert to someone may be sent via email (or any other communication method) that the technician's demand time is off The calculation may be based on the serial records in the data receive from the customer and the program types of the equipment. The calculation may add the demand times of the serial records assigned to the servicing technician to validate the total demand time.
The second check may be based on the technician's total calls for the month. If the technician performs more than 15% of the technician's service calls on equipment not assigned to the technician, there may be an integrity issue.
The third check may be based on the machines assigned to the technicians. If more than 15% of service calls on equipment assigned to a technician's territory are performed by some other technicians, there may be an integrity issue.

Exception Reports Feature

Exception reports may be used for the following reasons:
Unassigned Machines—Any machine that does not have a technician assigned for some reason. Some of the reasons may be as follows:
Machine not assigned a territory—A machine in a Working Area was not assigned a technician.
Technician not qualified—There are models assigned to a technician that the technician does not have enough experience based on ERP information to be qualified to work on.
Geo code creation—Prints out all addresses that were unable to gather geographic data codes. The report will allow customers to try and find an area for a geographic data code.

Automatic Car Stock Creation Feature
Run a query of machines assigned to technician's territory
Query all parts used by the technician's territory in the last six months and create an average monthly usage (i.e., a Territory AMU).
Query a number of times parts have been used in the previous six month period by how many machines and/or by number of service calls, and create a monthly usage report including items such as: Total Used, Total Machines and Total Service.
Recommended Car Stock—if a territory uses three or more of a part in six months an embodiment may recommend carrying one, or one set of the part be included in the car stock. If at 33% (i.e., two in six months) and if a common part, an embodiment may recommend that a technician carry one of the part (depending on cost).
If total usage for parts and models indicates the technician should carry a part, for instance if TotalUsed, TotalMachines and TotalService are each greater than X (which may be beneficially defaulted to 4 from prior experience using the system) then the car stock should include one of the part.
An embodiment may further display a report using the following format.

| Part | Part | Stock | Part | Extended | Territory | Total | Total | Total |
|---|---|---|---|---|---|---|---|---|
| Number | Descrip | Amount | Cost | Cost | AMU | Used | Machines | Service |
| 604K486 | MultiFeed | 1 | $31.19 | $31.19 | 0 | 19 | 18 | 19 |
| 604K118 | XModCRU | 1 | $99.99 | $99.99 | 0.5 | 115 | 107 | 115 |
| 113K296 | DevCharg | 1 | $12.50 | $12.50 | 0 | 8 | 6 | 8 |
| 604K996 | Spare Kit | 1 | $25.33 | $25.33 | 0.17 | 12 | 12 | 12 |
| 233K480 | Xfer Belt | 1 | $20.99 | $20.99 | 0.17 | 24 | 24 | 24 |
| 604K223 | FeedRoll | 1 | $85.04 | $85.04 | 0.66 | 59 | 41 | 42 |
| 604K500 | BeltKit | 2 | $6.46 | $6.46 | 0 | 19 | 18 | 19 |

EWD Sample Data Schema (Pseudo Code Class Definitions)
segment_type:
segment_type_id AUTO PK
segment_type_desc VARCHAR(30)
segments:
segment_id AUTO PK
segment_desc VARCHAR(4)
segment_type_id FK REFERENCES (sement_type_id)
UNIQUE (segment_desc)
bei_models:
bei_model_id AUTO PK
bei_model_number VARCHAR(30)
UNIQUE (bei_model_number)
models:
model_id AUTO PK
model_number VARCHAR(30)
segment_id FK REFERENCES segments (segment_id)
bei_model_id FK REFERENCES bei_models (bei_model_id)
UNIQUE (model_number)
locations:
location_id AUTO PK
location_geocode_lat
location_geocode_long
UNIQUE (location_geocode_lat, location_geocode_long)
customers:
customer_id AUTO PK
customer_number VARCHAR(30)
customer_address VARCHAR(100)
customer_state CHAR(2) ? Internationalzatin ?
custoemr_zip VARCHAR(10) XXXX-XXXX ? Internationalzatin ?
location_id FK REFERENCES locations (location_id)
serials:
serial_id AUTO PK
serial_number VARCHAR(30)
mt_demand TIME
model_id FK REFERENCES models (model_id)
customer_id FK REFERENCES customers (customer_id)
territory_id FK REFERENCES territories (territory_id)
UNIQUE (model_id,serial_number)
techs:
t_id AUTO PK
tech_number VARCHAR(10)
tech_first VARCHAR(20)
tech_last VARCHAR(20)
tech_address
tech_city
tech_state
tech_zip
UNIQUE (tech_number)
warehouse:
warehouse_id AUTO
warehouse_number VARCHAR(10)
warehouse_name VARCHAR(30)
warehouse_address
warehouse_city
warehouse_state
warehouse_zip
UNIQUE (warehouse_number)
techs models:
t_id PK FK REFERENCES techs (t_id)
model_id PK FK REFERENCES models (model_id)
is_trained BOOLEAN
world stats:
bei_model_id PK FK REFERENCES bei_models (bei_model_id)
world_stats_data (based on this bei model, most recent world stats report, yet to be defined)
dealer stats:
model_id PK FK REFERENCES models (model_id)
dealer_stats_data (based on this dealer, this model, most recent dealer stats report, yet to be defined)
tech_stats:
t_id PK FK REFERENCES techs (t_id)
model_id PK FK REFERENCES models (model_id)
tech_stats_data (based on this tech, this model, most recent tech stats report, yet to be defined)
work areas:
dealer_number CHAR(4) PK
work_area_id INT(0) AUTO PK
work_area_name VARCHAR(30)
work_area_polygon:
work_area_id FK REFERENCES world_areas (work_area_id)
wa_poly_id INT(0) ? AUTO
wa_poly_lat
wa_poly_long
territories:
territory_id INT(0) AUTO PK
territory_name VARCHAR(30) | defaults to tech name . . . probably not needed
t_workload TIME
work_area_id FK REFERENCES world_areas (work_area_id)
t_id FK REFERENCES techs (t_id)
we might want to add nat_workload as well
territory_polygon:
territory_id FK REFERENCES territories (t_id)
poly_id ? AUTO
poly_lat
poly_long

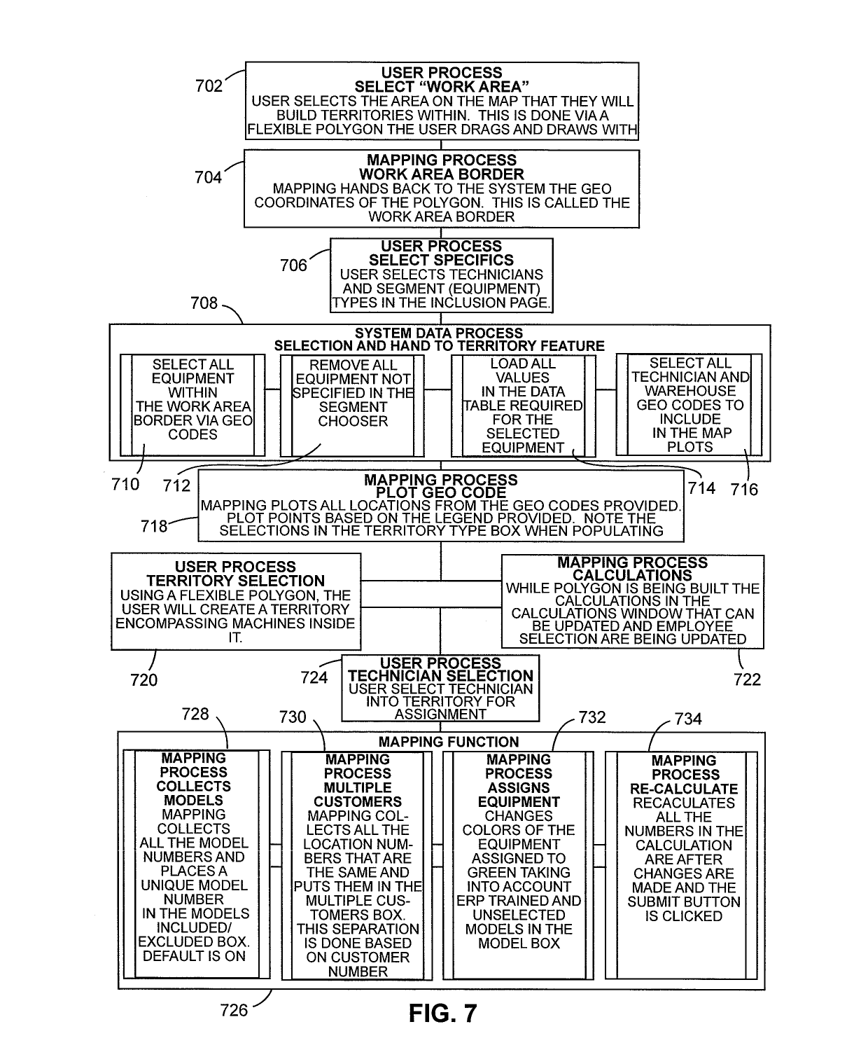

FIG. 7 is a detailed flowchart of an embodiment using a map based interface to set sample territories (i.e., geographic area of interest) for an embodiment. Step 702 is a user process for selecting the work area. For an embodiment, a user may select an area on the map that will then be used for building territories within. The selection process may be done via a flexible polygon that user may drag and draw. Step 704 is a mapping process that handles the work area border. The mapping process of step 704 may hand the geographic coordinates of the work area polygon to the system. The coordinates handed back may be referred to as the Work Area Border. Step 706 is a user process that includes sub-processes 710-716 for selecting the specific attributes of the work area such as the technicians and segments (i.e., equipment) types in the Inclusion page (FIG. 4). Step 708 is a system data process for selecting data and handing the data to the Territory feature/page (FIG. 5). At sub-process 710, equipment within the Work Area Border is selected via GEO codes. At sub-process 712, equipment not selected in the segment chooser is removed. At sub-process 714, the necessary values are loaded into a data table for the selected equipment. At sub-process 716, by default the technicians and warehouse GEO codes to include in the map plots on the Territory page (FIG. 4). Step 718 is a mapping process for plotting GEO codes. For an embodiment, the mapping process of step 718 may plot the necessary locations from the provided GEO codes based on the provided map legend and taking into account the Territory Type information from the Inclusion page (FIG. 4) as necessary. Step 720 is a user process for selecting a territory. An embodiment may permit a user to create a territory using a flexible polygon that encompasses all of the machines/devices desired to be in the territory being created. Step 722 is a mapping process that performs calculations (see item 558 of FIG. 5) for a territory. Steps 720 and 722 may be performed concurrently such that the calculations of step 722 are performed and reported dynamically as the user makes changes to a territory, including changes to the assigned technician for the territory of step 724. Step 724 is a user process for selecting and assigning a technician for a territory. Step 726 is a mapping function made up of sub-processes 728-734. At sub-process 728, the system collects the model numbers and places each model number (not including repeats, that is, unique model numbers) in the Models list for the Territory page. At sub-process 730, the system collects location numbers that are the same and places the same numbers in the multiple customers box of the Territory page. Separation of the location numbers is performed based on the customer number associated with each machine/device. At sub-process 732, equipment is assigned to a territory taking into account ERP trained and unselected models in the Model list of the Territory page (FIG. 4). At sub-process 734, the system automatically and dynamically recalculates and updates the display with the current data. Submitting may be selected to store the changes to a territory.

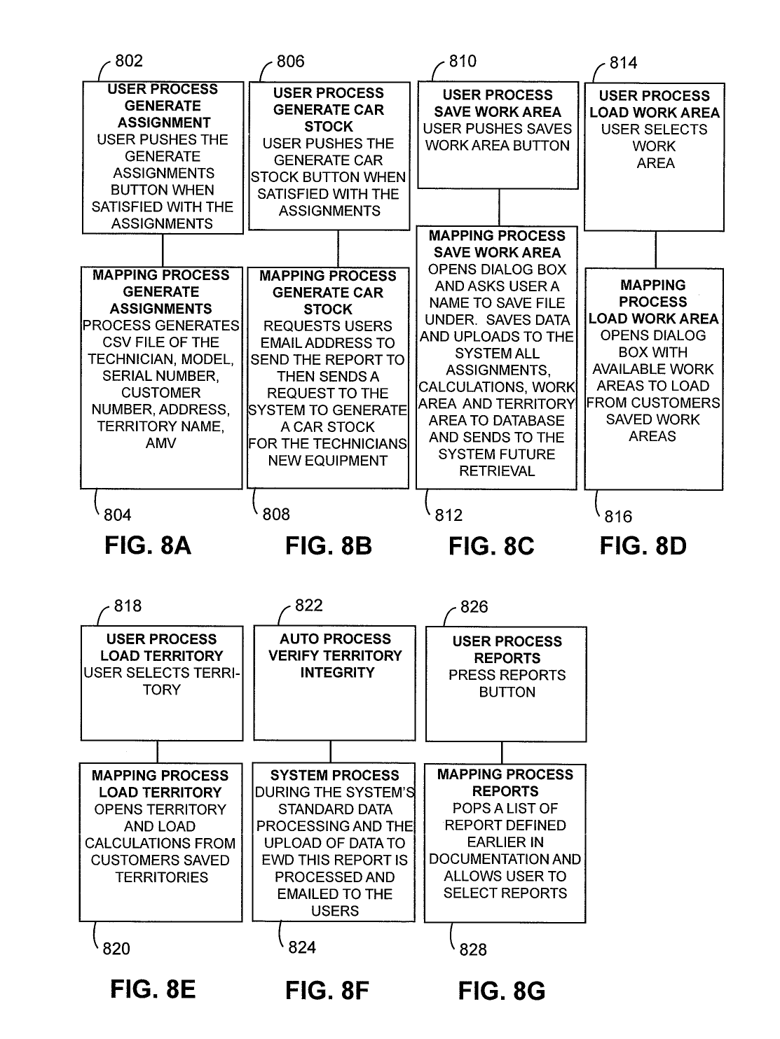

FIGS. 8A-G are detailed flowcharts describing operations for various buttons of a map based user interface of the Work Area (FIG. 2) and Territory (FIG. 4) pages for an embodiment. FIG. 8A is a flow chart describing a process for generating a territory based assignments. Step 802 is a user process for generating assignments by having the user press a button when satisfied with assignments. Step 804 is a mapping process that generates a CSV file of the technician, model, serial number, customer number, address, territory name, AMV, segment, and/or any fewer or more values necessary to properly define an assignment of a machine/device to a technician/territory.

FIG. 8B is a flow chart describing a process for generating car stock. Step 806 is a user process of pushing a button to initiate the process for generating a car stock list. Step 808 is a mapping process that requests a user e-mail address to send the car stock report and then sends a request to the system to generate/create a car stock report for a technician's equipment.

FIG. 8C is a flow chart describing the process for saving a work area. Step 810 is a user process of pushing a button to save a work area. Step 812 is a mapping process that opens a dialog box and asks for a user name to save the work area file under, saves the data and uploads to the system the assignments, calculations, work area, and territory area to the system database for future retrieval.

FIG. 8D is a flow chart describing the process for loading a work area. Step 814 is a user process where the user chooses to select a saved work area. Step 816 is a mapping process for loading the selected work area by opening a dialog box, having the user select a saved work area from the dialog box, and loading the selected saved work area.

FIG. 8E is a flow chart describing the process for loading a territory. Step 818 is a user process where the user selects a desired territory. Step 820 is a mapping process for loading the selected territory by opening the selected territory and loading calculations from the saved territories.

FIG. 8F is a flow chart describing the process for territory integrity checks. Step 822 is an automatic process for verifying territory integrity. Step 824 is a system process for creating a territory integrity report and uploading the data to the Effective Workload Distribution (EWD) system.

FIG. 8G is a flow chart describing the process for reports. Step 826 is a user process where the user presses a reports button. Step 828 is a mapping process that brings up a list of potential reports for the user to select from and then generates whichever report user has selected.

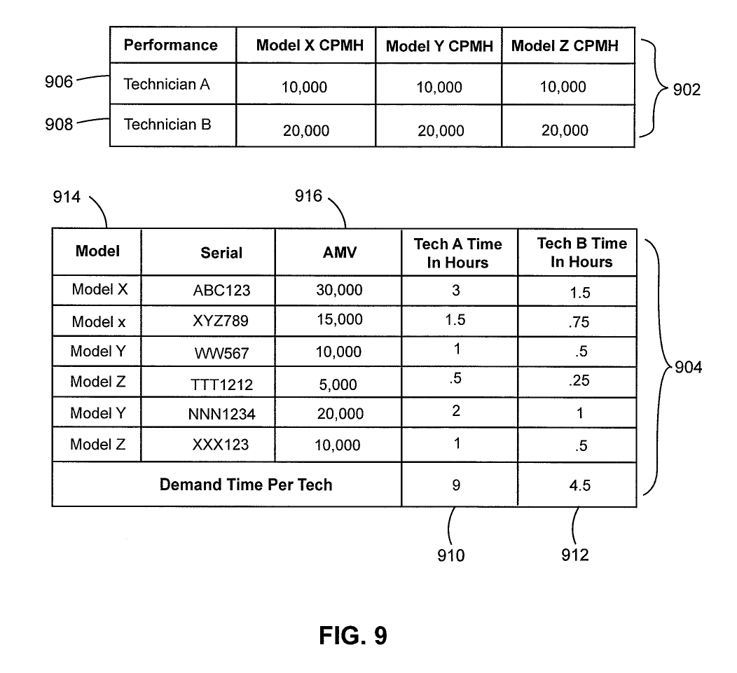

FIG. 9 is a schematic illustration of a technician performance report for an embodiment. Section 902 of the performance report of FIG. 9 provides the Copies Per Maintenance Hour (CPMH) for two technicians (A-906 and B-908). Section 904 shows the demand time for each technician (A-910 and B-912) versus the Average Monthly Volume (AMV) 916 for the model/equipment 914 associated with the technician demand time for the same units (i.e., units with the same serial number) for technicians A-. As may be noted, the CPMH for Technician A-906 is roughly half (10,000 versus 20,000) of the CPMH for technician B-908. As may be seen, in section 904, with the same AMV 916, technician A-910 has twice the demand time of technician B-912. Therefore, it is evident that technician B-908/912 is twice as effective as technician A-906/910 based on the CPMH (as inversely related to the demand time per AMV 916 for the same models 914).

Various embodiments may provide the control and management functions detailed herein via an application operating on a computer system (or other electronic devices). Embodiments may be provided as a computer program product which may include a computer-readable, or machine-readable, medium having stored thereon instructions which may be used to program/operate a computer (or other electronic devices) or computer system to perform a process or processes in accordance with the present invention. The computer-readable medium may include, but is not limited to, hard disk drives, floppy diskettes, optical disks, Compact Disc Read-Only Memories (CD-ROMs), Digital Versatile Disc ROMS (DVD-ROMs), Universal Serial Bus (USB) memory sticks, magneto-optical disks, ROMs, random access memories (RAMs), Erasable Programmable ROMs (EPROMs), Electrically Erasable Programmable ROMs (EEPROMs), magnetic optical cards, flash memory, or other types of media/machine-readable medium suitable for storing electronic instructions. The computer program instructions may reside and operate on a single computer/electronic device or various portions may be spread over multiple computers/devices that comprise a computer system. Moreover, embodiments may also be downloaded as a computer program product, wherein the program may be transferred from a remote computer to a requesting computer by way of data signals embodied in a carrier wave or other propagation medium via a communication link (e.g., a modem or network connection, including both wired/cabled and wireless connections).

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A computerized method for optimally assigning service territories to a service technician comprising:
providing access to a database stored on computer readable media by a computer system, said database containing geographic location data, unit type data, historical usage data, and historical repair data for each serviceable unit of a plurality of serviceable units, said database further containing historical repair success data and historical repair time data for each service technician of a plurality of service technicians;
selecting by said computer system a territory geographic area of interest;
selecting by said computer system a subset of serviceable units from said plurality of serviceable units stored in said database such that said subset of serviceable units contains serviceable units of said plurality of serviceable units that have said geographic location data located within said territory geographic area of interest;
selecting by said computer system a service technician from said plurality of service technicians stored in said database;
calculating by said computer system an aggregated technician demand time as a function of said unit type data of said selected subset of serviceable units, said historical usage data for each serviceable unit of said selected subset of serviceable units, said historical repair data for each serviceable unit of said selected subset of serviceable units, said historical repair success data for said selected service technician, and said historical repair time data for said service technician stored in said database;
recalculating said aggregated technician demand time by said computer system dynamically if characteristics of said territory geographic area of interest change; and
displaying results of said calculations and said recalculations dynamically as said calculations and said recalculations are performed to a user.

2. The method of claim 1 further comprising assigning said territory geographic area of interest to said selected service technician as a service territory for said selected service technician.

3. The method of claim 1 wherein said characteristics of said territory geographic area of interest are comprised of at least one of a group consisting of: size of said territory geographic area of interest consist, manufacturers associated with said territory geographic area of interest consist, equipment types/segments associated with said territory geographic area of interest consist, equipment models associated with said territory geographic area of interest consist, customers associated with said territory geographic area of interest consist, and said selected service technician associated with said territory geographic area of interest consist.

4. The method of claim 1 further comprising automatically adjusting a size of said territory geographic area of interest with respect to a number of serviceable units in said subset of serviceable units, reselecting said subset of serviceable units from said plurality of serviceable units based on said adjusted territory geographic area of interest, and recalculating said aggregated technician demand time by said computer system until said aggregated technician demand time falls within a desired aggregated technician demand time range, said adjustment of said territory geographic area of interest increases said size of said territory geographic area of interest if said calculated aggregated technician demand time is less than said desired aggregated technician demand time range and decreases said size of said territory geographic area of interest if said calculated aggregated technician demand time is more than said desired aggregated technician demand time range.

5. The method of claim 1 further comprising:
selecting by said user interacting with said computer system an initial work geographic area of interest; and
limiting by said computer system said territory geographic area of interest such that said territory geographic area of interest is contained within said work geographic area of interest.

6. The method of claim 1 further comprising filtering said subset of serviceable units to only include serviceable units having a desired subset of said unit type data.

7. The method of claim 1 wherein said database further contains owner/customer data for each serviceable unit of said plurality of serviceable units and further comprises filtering said subset of serviceable units to only include serviceable units owned by desired owners/customers.

8. The method of claim 1 wherein said database further contains repair certification data for each service technician of said plurality of service technicians and further comprises filtering said subset of serviceable units to only include serviceable units having said unit type data matching said repair certification data of said selected service technician.

9. The method of claim 1 further comprising switching said selected service technician to a different service technician to calculate said aggregated technician demand time in order to assign said service territory.

10. The method of claim 1 wherein said adjusting of said territory geographic area of interest is performed manually by a user through a graphical user interface with said computer system.

11. The method of claim 6 wherein said switching of said selected service technician is performed manually by a user through a graphical user interface with said computer system.

12. The method of claim 6 wherein said adjusting of said service technician is performed automatically by said computer system.

13. The method of claim 1 further comprising generating a part stock list for a vehicle of said service technician based on said subset of serviceable units in said service territory for said selected service technician and based on said unit type data, said historical usage data, and said historical repair data for each serviceable unit of said subset of serviceable units in said service territory of said service technician.

14. The method of claim 1 further comprising checking territory integrity of said service territory assigned to said service technician on a periodic basis to identify when said selected service technician is not performing a predefined percentage of service calls in said service territory of said service technician and issuing an alert if said territory integrity of said assigned service territory falls outside a predefined, configurable and acceptable territory integrity range.

15. The method of claim 1 wherein said service area is assigned to said selected service technician by assigning said subset of serviceable units in said territory geographic area of interest to said selected service technician.

16. A system for optimally assigning service territories to a service technician comprising:
a computer system that performs functions of said system for optimally assigning service territories;
computer readable media accessible by said computer system;
a database stored on said computer readable media and accessible to said computer system, said database containing geographic location data, unit type data, historical usage data, and historical repair data for each serviceable unit of a plurality of serviceable units, said database further containing historical repair success data and historical repair time data for each service technician of a plurality of service technicians;
a territory geographic area selection engine running on said computer system that selects a territory geographic area of interest and selects a subset of serviceable units from said plurality of serviceable units stored in said database such that said subset of serviceable units contains serviceable units of said plurality of serviceable units that have said geographic location data located within said territory geographic area of interest;
a service technician selection engine that selects a service technician from said plurality of service technicians stored in said database;
an aggregated technician demand timer calculation engine that calculates an aggregated technician demand time as a function of said unit type data of said selected subset of serviceable units, said historical usage data for each serviceable unit of said selected subset of serviceable units, said historical repair data for each serviceable unit of said selected subset of serviceable units, said historical repair success data for said selected service technician, and said historical repair time data for said service technician stored in said database and that recalculates said aggregated technician demand time dynamically if characteristics of said territory geographic area of interest change; and
a display results engine that displays results of said calculations and said recalculations dynamically as said calculations and said recalculations are performed to said user.

17. The system of claim 16 further comprising a territory assignment engine that assigns said territory geographic area of interest to said selected service technician as a service territory for said selected service technician.

18. The system of claim 16 further comprising a territory geographic area adjustment engine that automatically adjusts a size of said territory geographic area of interest with respect to a number of serviceable units in said subset of serviceable units, reselects said subset of serviceable units from said plurality of serviceable units based on said adjusted territory geographic area of interest, and recalculates said aggregated technician demand time until said aggregated technician demand time falls within a desired aggregated technician demand time range, said adjustment of said territory geographic area of interest increases said size of said territory geographic area of interest if said calculated aggregated technician demand time is less than said desired aggregated technician demand time range and decreases said size of said territory geographic area of interest if said calculated aggregated technician demand time is more than said desired aggregated technician demand time range.

19. The system of claim 16 wherein said service technician selection engine further switches said selected service technician to a different service technician to calculate said aggregated technician demand time in order to assign said service territory.

20. The system of claim 16 further comprising a territory integrity check engine that checks territory integrity of said service territory assigned to said service technician on a periodic basis to identify when said selected service technician is not performing a predefined percentage of service calls in said service territory of said service technician and issues an alert if said territory integrity of said assigned service territory falls outside a predefined, configurable and acceptable territory integrity range.
